(19) United States
(12) Patent Application Publication
(10) Pub. No.: US 2025/0388035 A1
(43) Pub. Date: Dec. 25, 2025

(54) PRINTING DEVICE

(71) Applicant: SEIKO EPSON CORPORATION, Tokyo (JP)

(72) Inventors: Kazuki MANO, Nagano-shi (JP); Takuro ISHIKURA, Ueda-shi (JP); Kiyotaka OGURA, Azumino-shi (JP)

(21) Appl. No.: 19/247,090

(22) Filed: Jun. 24, 2025

(30) Foreign Application Priority Data
Jun. 25, 2024 (JP) 2024-101819

(51) Int. Cl. B41J 29/13; B41J 2/175

(52) U.S. Cl. CPC B41J 29/13; B41J 2/175

(57) ABSTRACT

A printing device includes a head configured to eject liquid, a housing that has a cover configured to open and close and that is configured to accommodate the head, a supply tube configured to supply the liquid to the head, a connection section configured to attachably and detachably connect the supply tube to head, a connection section side engagement section provided on the connection section, and a housing side engagement section provided inside the cover, wherein the connection section side engagement section is configured to engage with the housing side engagement section in a state where the cover is opened, the housing side engagement section, which is positioned at the storage position P2, is configured to move to an engagement position where the connection section side engagement section is configured to, by pivoting around a pivot shaft, engage with the connection section side engagement section, and the center of gravity of the housing side engagement section is positioned on an opposite side to the side that engages with the connection section side engagement section with the pivot shaft interposed therebetween.

The present application is based on, and claims priority from JP Application Serial Number 2024-101819, filed Jun. 25, 2024, the disclosure of which is hereby incorporated by reference herein in its entirety.

### BACKGROUND

### 1. Technical Field

The present disclosure relates to a printing devices such as printers.

### 2. Related Art

For example, as disclosed in JP-A-2007-105883, there is an inkjet recording device, which is an example of a printing device, that ejects ink, which is an example of a liquid, from an inkjet head, which is an example of a head, to perform printing. The inkjet recording device includes an ink tube, which is an example of a supply tube, a cover member, which is an example of a cover, and a septum unit, which is an example of a connection section.

The ink tube is supported by the cover member. The cover member is pivotable. When the cover member is in a closed state, the septum unit fits onto the inkjet head, and the ink tube is connected to the inkjet head. When the cover member is opened, the ink tube detaches from the inkjet head, allowing for the replacement of the inkjet head.

The cover member of JP-A-2007-105883 is supported to pivot with respect to a carriage on an opposite side interposed a guide rail from a side closing the inkjet head, and is opened by pivoting the cover member around a support section. At this time, the cover member pivots in such a way as to deform the ink tube. Therefore, the opened cover member may be moved by the force of the ink tube trying to return to its original shape.

In order to maintain the cover member in an open state, for example, a housing side engagement section that can engage with the connection section is provided, the connection section can be held even if the supply tube is in a deformed state. However, printing is performed with the connection section, which separates from the housing side engagement section, connected to the head. In a state in which the housing side engagement section is separated from the connection section, the housing side engagement section needs to be held so as not to hinder printing. However, if the posture of the housing side engagement section changes due to vibration or the like during printing and interferes with the operation of the head, the printing may be affected.

### SUMMARY

A printing device that solves the above problem, the printing device includes a head configured to eject liquid; a housing that has a cover configured to open and close and that is configured to accommodate the head; a supply tube configured to supply the liquid to the head; a connection section configured to attachably and detachably connect the supply tube to the head; a connection section side engagement section provided on the connection section; and a housing side engagement section provided inside the cover, wherein the connection section side engagement section is configured to engage with the housing side engagement section in a state where the cover is open, the housing side engagement section positioned in a storage position is movable, by pivoting around a pivot shaft, to an engagement position where the housing side engagement section is engageable with the connection section side engagement section, and the center of gravity of the housing side engagement section is positioned on an opposite side to a side that engages with the connection section side engagement section with the pivot shaft interposed therebetween.

### BRIEF DESCRIPTION OF THE DRAWINGS

FIG. 1 is a schematic view of an embodiment of a printing device.

FIG. 2 is a schematic view of the printing device in which a housing side engagement section is positioned at a storage position.

FIG. 3 is a schematic view of the printing device in which the housing side engagement section is positioned at an engagement position.

FIG. 4 is a schematic view of the printing device in which the housing side engagement section and a connection section side engagement section are engaged with each other.

FIG. 5 is an arrow view cross-sectional view taken along lines 5-5 in FIG. 4.

FIG. 6 is a schematic view of the housing side engagement section attached to a bearing section.

FIG. 7 is a schematic view of the housing side engagement section attached to the bearing section.

### DESCRIPTION OF EMBODIMENTS

### Embodiments

Hereinafter, an embodiment of a printing device will be described with reference to the drawings. The printing device is an inkjet printer that performs printing by ejecting ink, which is an example of a liquid, onto a medium such as paper sheet, fabric, vinyl sheet, plastic component, or metal component.

In the drawings, assuming that a printing device 11 is placed on a horizontal plane, a direction of gravity is indicated by a Z-axis, and directions along the horizontal plane are indicated by an X-axis and a Y-axis. The X-axis, the Y-axis, and the Z-axis are orthogonal to each other. In the following description, a direction parallel to the X-axis is also referred to as a width direction X, a direction parallel to the Y-axis is referred to as a depth direction Y, and a direction parallel to the Z-axis is referred to as a vertical direction Z.

### Printing Device

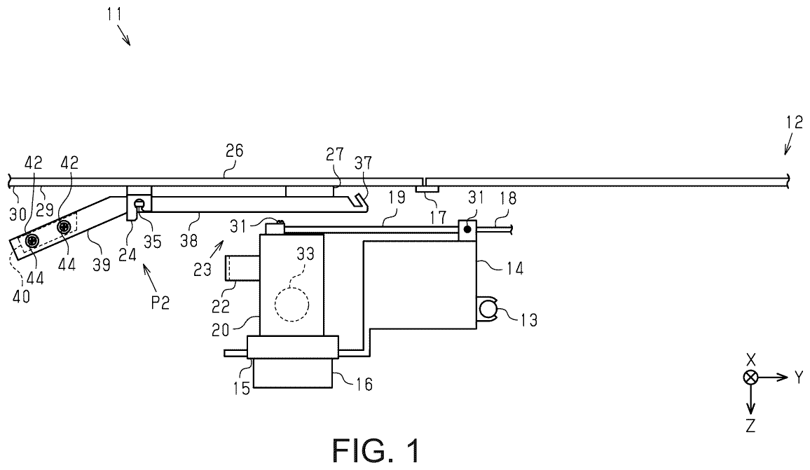

As shown in FIG. 1, the printing device 11 includes a housing 12. The printing device 11 may include a guide shaft 13, a carriage 14, a head 15, a cap 16, and an illumination 17. The printing device 11 may include a supply tube 18, a protection section 19, and a connection section 20. The printing device 11 may include a connection section side engagement section 22, a housing side engagement section 23, and a bearing section 24.

### Housing

The housing 12 accommodates various components of the printing device 11. The housing 12 accommodates the head 15. The housing 12 accommodates the connection section 20. The housing 12 may have a cover 26 and a limiting section 27.

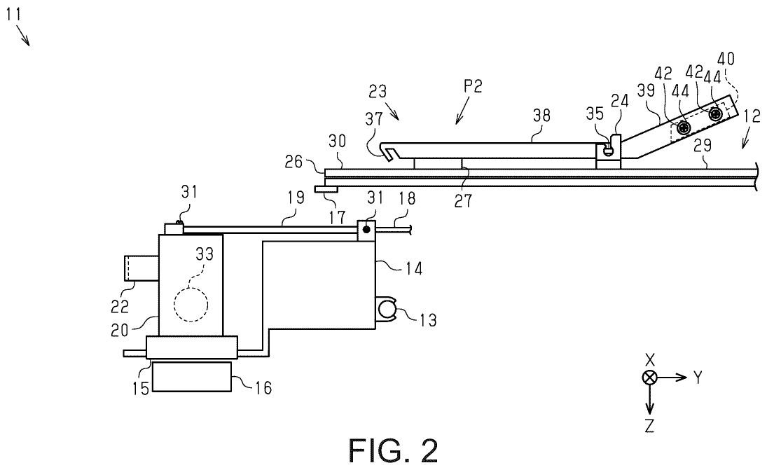

As shown in FIG. 1 and FIG. 2, the cover 26 is provided so as to be openable and closable. The cover 26, in the depth direction Y, may be opened and closed by pivoting around an axis (not shown) provided between the connection section 20 and the guide shaft 13. Pivoting refers to pivoting around an axis, wherein the pivotable angle is less than 360 degrees. For example, the cover 26 is configured to assume a closed position shown in FIG. 1 and an open position shown in FIG. 2. The cover 26 positioned at the closed position covers the connection section 20. The cover 26 positioned at the open position exposes the connection section 20. The cover 26 may have a stopper 29. The stopper 29 may be provided on an inner surface 30 of the cover 26.

As shown in FIG. 1, the inner surface 30 is a surface facing the inside of the housing 12 in the cover 26 positioned at the closed position. The inner surface 30 is a lower surface of the cover 26 positioned at the closed position.

As shown in FIG. 2, the inner surface 30 is an upper surface of the cover 26 positioned at the open position. The open position of the cover 26 is a position in which the inner surface 30 faces outward.

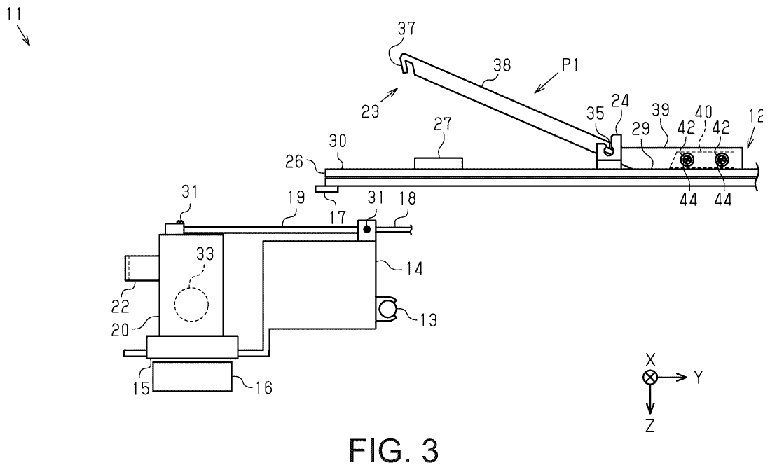

As shown in FIG. 3, the stopper 29 limits the movement of the housing side engagement section 23 positioned at an engagement position P1. The stopper 29 may be the same plane as the inner surface 30. The stopper 29 limits the pivoting of the housing side engagement section 23 in a clockwise direction in FIG. 3.

As shown in FIG. 1 and FIG. 2, the limiting section 27 limits the pivoting of the housing side engagement section 23 positioned at a storage position P2. The limiting section 27 may be provided on the cover 26. When a part or the whole of the housing side engagement section 23 is composed of a magnetic material, the limiting section 27 may be a magnet. A part of the housing side engagement section 23 is composed of a magnet, and the limiting section 27 may be a magnetic material.

### Internal Configuration

As shown in FIG. 1, the guide shaft 13 extends in the width direction X. The guide shaft 13 guides the movement of the carriage 14.

The carriage 14 may reciprocate along the guide shaft 13.

The head 15 and the connection section 20 are mounted on the carriage 14. The head 15 is capable of ejecting the liquid. The head 15 ejects the liquid from a plurality of nozzles (not shown). The head 15 performs printing by ejecting the liquid onto the medium.

The cap 16 is movable between a capping position shown in FIG. 1 and an opening position shown in FIG. 2. The cap 16 positioned at the capping position contacts with the head 15 so as to cover the nozzles, thereby capping the head 15 and sealing the space facing the nozzles. The cap 16 positioned at the opening position separates from the head 15, thereby opening the nozzles. The cap 16 may move between the capping position and the opening position in conjunction with the movement of the carriage 14. The printing device 11 may include a moving mechanism (not shown) that moves the cap 16.

The illumination 17 may illuminate the inside of the housing 12. The illumination 17 may illuminate the moving carriage 14. The illumination 17 may illuminate the medium to be printed. The illumination 17 may be provided at a position different from the cover 26 in the width direction X. The illumination 17 may extend in the width direction X.

The printing device 11 may include a plurality of protection sections 19 and a plurality of supply tubes 18. Each of the plurality of protection sections 19 and the plurality of supply tubes 18 may extend in the depth direction Y. The plurality of protection sections 19 and the plurality of supply tubes 18 may be provided parallel to each other. The plurality of protection sections 19 and the plurality of supply tubes 18 may be disposed in a row in the width direction X. The plurality of protection sections 19 may be provided on both sides of the plurality of supply tubes 18 in the width direction X. The plurality of supply tubes 18 may be provided between the plurality of protection sections 19.

The protection section 19 may have a cylindrical shape. The protection section 19 is, for example, a hollow tube. The protection section 19 may have elasticity. The protection section 19 is made of, for example, polyurethane.

The plurality of protection sections 19 are fixed to the connection section 20 and the carriage 14. One end of the protection section 19 is fixed to the connection section 20. The other end of the protection section 19 is fixed to the carriage 14. The protection section 19 may be fixed by a first screw 31.

The supply tube 18 may be held by the connection section 20 and the carriage 14. The positions at which the plurality of supply tubes 18 are held and the position at which the protection section 19 is fixed may be disposed in a row in the width direction X, for example.

The supply tube 18 may have elasticity. The supply tube 18 may be constructed of fluororesin. An upstream end of each of the plurality of supply tubes 18 communicates with, for example, a plurality of liquid containing sections (not shown), and a downstream end thereof is connected to the connection section 20. The plurality of supply tubes 18 may supply the different types of liquids. The different types of liquids are, for example, the inks of different colors. The plurality of supply tubes 18 supply the liquid with respect to the head 15. The supply tube 18 can supply the liquid stored in the liquid containing section to the head 15 through the connection section 20.

### Connection Section

The connection section 20 attachably and detachably connects the plurality of supply tubes 18 to the head 15. The connection section 20 is connected to the head 15. The connection section 20 is attachably and detachably fixed to the carriage 14 in a state in which the liquid can be supplied to the head 15. The connection section 20 may have a liquid flow adjustment section 33.

The liquid flow adjustment section 33 adjusts the flow of the liquid supplied by the supply tube 18. The liquid flow adjustment section 33 is, for example, a differential pressure valve or a pressure reducing valve. When the liquid is consumed in the head 15, the liquid pressure between the liquid flow adjustment section 33 and the head 15 decreases. When the liquid pressure between the liquid flow adjustment section 33 and the head 15 falls below a predetermined pressure lower than atmospheric pressure, the liquid flow adjustment section 33 opens. The opened liquid flow adjustment section 33 allows the liquid to flow from the connection section 20 toward the head 15.

When the liquid flows from the connection section 20 toward the head 15, the liquid pressure between the liquid flow adjustment section 33 and the head 15 increases. When the liquid pressure between the liquid flow adjustment section 33 and the head 15 returns to the predetermined pressure, the liquid flow adjustment section 33 is closed. The closed liquid flow adjustment section 33 stops the liquid to flow from the connection section 20 toward the head 15. The liquid flow adjustment section 33 does not open even when the liquid pressure between the liquid flow adjustment section 33 and the head 15 becomes high. Therefore, the liquid flow adjustment section 33 functions as a one-way valve, that is, a so-called check valve, which allows the liquid to flow from the connection section 20 to the head 15 and suppresses the liquid from flowing from the head 15 to the connection section 20.

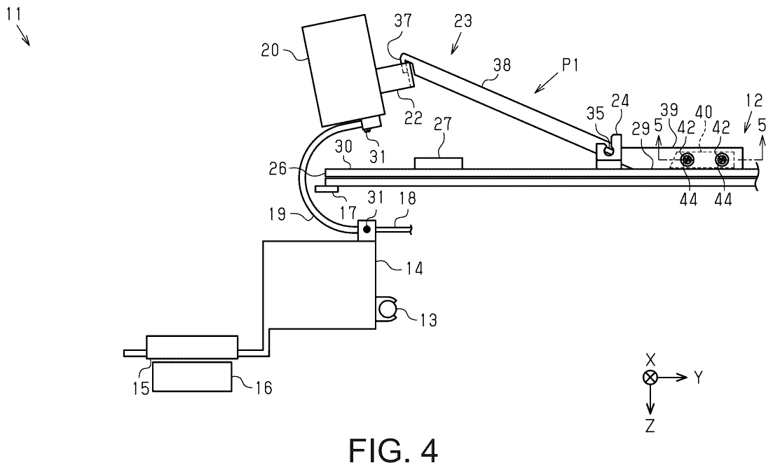

As shown in FIG. 4, the connection section 20, which has been released from the fixation with respect to the carriage 14, becomes movable with respect to the head 15 and the carriage 14. When the connection section 20 is separated from the carriage 14, the connection between the head 15 and the connection section 20 is released. The connection section 20 is movable while the protection section 19 and the supply tube 18 are connected to each other. The connection section 20 moves together with the plurality of supply tubes 18 and a portion of the plurality of protection sections 19. The connection section 20 is movable between a printing position shown in FIG. 1 and a retracting position shown in FIG. 4.

The printing position is a position at which the connection section 20 is positioned at the time of printing. When the connection section 20 is positioned at the printing position, the carriage 14 is movable along the guide shaft 13. The retracting position is a position where the connection section 20 retracts from the printing position. The retracting position may be a position above the printing position. The posture of the connection section 20 may change between the printing position and the retracting position. The retracting posture of the connection section 20 at the retracting position may be inverted with respect to the printing posture at the printing position.

### Connection Section Side Engagement Section

As shown in FIG. 1 and FIG. 4, the connection section side engagement section 22 is provided on the connection section 20. The connection section side engagement section 22 moves to the printing position and the retracting position together with the connection section 20. The connection section side engagement section 22 takes a printing posture and a retracting posture together with the connection section 20. Assuming that a direction in which the protection section 19 and the supply tube 18 extend from the connection section 20 is a rear direction, the connection section side engagement section 22 may be provided on a front surface of the connection section 20 in the printing posture.

As shown in FIG. 4, the connection section side engagement section 22 can be engaged with the housing side engagement section 23 in a state where the cover 26 is opened. When the connection section 20 is detached from the carriage 14, the head 15 disengages from the connection section 20 and remains on the carriage 14. Therefore, the connection section side engagement section 22 is engageable with the housing side engagement section 23 in a state of disengaging the connection section 20 from the head 15.

### Housing Side Engagement Section

The housing side engagement section 23 is provided in the housing 12. The housing side engagement section 23 of the present embodiment is provided inside the cover 26. The housing side engagement section 23 may be provided on the inner surface 30. The housing side engagement section 23 may be inflexible. Here, having inflexibility means that even when the housing side engagement section 23 receives a force such as the elastic force of the protection section 19, the housing side engagement section 23 itself does not bend, and the shape of the housing side engagement section 23 itself can be maintained. The housing side engagement section 23 is provided so as to be pivotable around a pivot shaft 35.

The housing side engagement section 23 may include a hook 37, an arm section 38, a tail section 39, and a weight 40.

The hook 37 may be provided at a tip end of the arm section 38. The hook 37 and the arm section 38 are positioned on the same side with respect to the pivot shaft 35. The hook 37 is engageable with the connection section side engagement section 22.

The tail section 39 is positioned on the opposite side of the hook 37 side with the pivot shaft 35 interposed therebetween. When the housing side engagement section 23 is positioned at the engagement position P1, the tail section 39 contacts against the stopper 29. That is, the stopper 29 is positioned on the opposite side of the hook 37 with the pivot shaft 35 interposed therebetween.

The weight 40 is provided on the tail section 39. That is, the weight 40 is provided on the opposite side of the hook 37 side with the pivot shaft 35 interposed therebetween. The weight 40 adjusts the position of the center of gravity of the housing side engagement section 23. The center of gravity of the housing side engagement section 23 is positioned in the tail section 39.

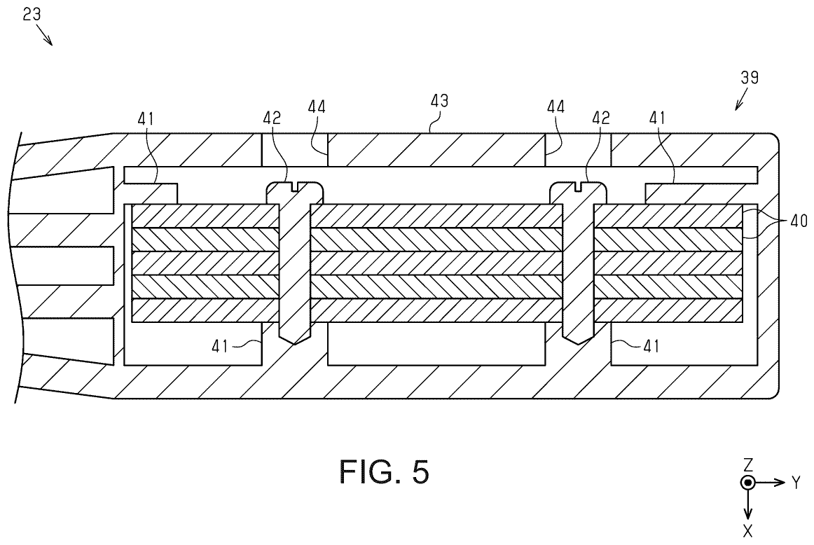

As shown in FIG. 5, the housing side engagement section 23 may have one or more plate-shaped weights 40. The plurality of weights 40 may be provided in an overlapping manner in the width direction X. The weight 40 may be provided at the center of the tail section 39 in the width direction X. The tail section 39 may have one or more spacers 41. The plurality of spacers 41 may support the weight 40 so as to sandwich the weight 40 from both sides in the width direction X. The weight 40 may be fixed by one or more second screws 42. The second screw 42 may fix the weight 40 to the spacer 41. When a large hole 44 larger than a head of the second screw 42 is provided in a sidewall 43 of the tail section 39, the weight 40 can be easily fixed.

As shown in FIG. 2, when the housing side engagement section 23 is positioned at the storage position P2, the arm section 38 is aligned along the inner surface 30. The housing side engagement section 23 positioned at the storage position P2 moves to the engagement position P1 shown in FIG. 3 by pivoting around the pivot shaft 35 so that the hook 37 moves away from the inner surface 30.

As shown in FIG. 4, the engagement position P1 is a position capable of engaging the hook 37 to the connection section side engagement section 22. The engagement position P1 is a position where the hook 37 is away from the inner surface 30. The engagement position P1 is a position where the tail section 39 contacts the stopper 29. In a direction perpendicular to the inner surface 30, the distance between the hook 37 positioned at the engagement position P1 and the inner surface 30 is larger than the distance between the hook 37 positioned at the storage position P2 and the inner surface 30.

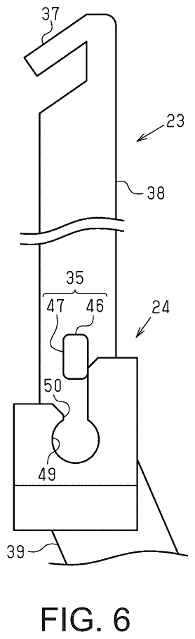

As shown in FIG. 6, the pivot shaft 35 has a shaft section 46 and a thin section 47. The thin section 47 is narrower than the diameter of the shaft section 46.

The bearing section 24 receives the pivot shaft 35. The bearing section 24 may have a support section 49 and a guide section 50. The support section 49 has a sliding surface for sliding the shaft section 46, pivotably supporting the pivot shaft 35. Specifically, the support section 49 can support the shaft section 46. The guide section 50 guides the pivot shaft 35 to be attached to the support section 49. In the housing side engagement section 23 of the attachment posture shown in FIG. 6, the width of the thin section 47 is smaller than the width of the guide section 50. The attachment posture is a posture with respect to the bearing section 24. In the housing side engagement section 23 in the attachment posture, the pivot shaft 35 passes through the guide section 50. The guide section 50 guides the pivot shaft 35 to the support section 49. The housing side engagement section 23 is attached to the bearing section 24 by relatively moving with respect to the bearing section 24 in the attachment posture.

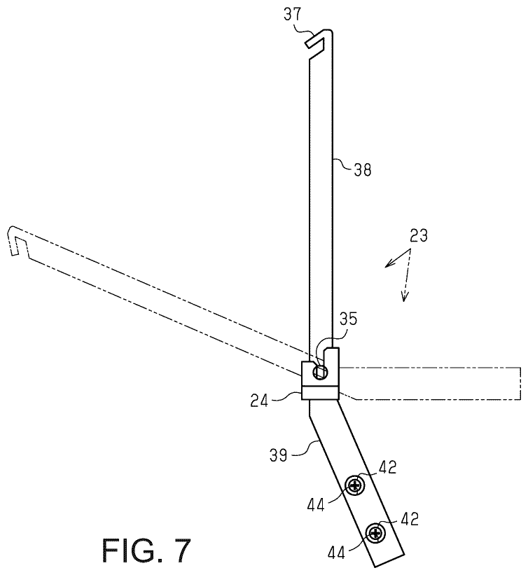

The housing side engagement section 23 attached to the bearing section 24 in the attachment posture shown by a solid line in FIG. 7 is pivotable so that the shaft section 46 is along the sliding surface of the support section 49. As indicated by a two dot chain line in FIG. 7, the housing side engagement section 23 is prevented from being detached from the bearing section 24 by being pivoted with respect to the bearing section 24.

As shown in FIG. 3, the bearing section 24 to which the housing side engagement section 23 is attached is fixed to the cover 26. When the bearing section 24 is fixed to the cover 26, the posture of the housing side engagement section 23 is limited. That is, a pivot range of the housing side engagement section 23 is limited between the storage position P2 and the engagement position P1. The housing side engagement section 23 that pivots between the storage position P2 and the engagement position P1 does not take the attachment posture. The pivot range of the housing side engagement section 23 provided on the cover 26 together with the bearing section 24 is a range in which the thin section 47 of the pivot shaft 35 reaches the guide section 50 of the bearing section 24 and the pivot shaft 35 does not come off from the bearing section 24.

### Operation of Present Embodiment

The operation of the present embodiment will be described.

As shown in FIG. 1 and FIG. 2, when the head 15 is to be replaced, a user moves the cover 26 from the closed position to the open position. At this time, the housing side engagement section 23 is limited from moving relative to the cover 26 by the limiting section 27. Therefore, the housing side engagement section 23 moves integrally with the cover 26 while maintaining the storage position P2 with respect to the cover 26. When cover 26 is opened, the user can access the connection section 20 and the housing side engagement section 23.

The cap 16 may move to the opening position, for example, in conjunction with the cover 26 moving to the opening position. The cap 16 may be moved to the opening position based on a user instruction. The replacement of head 15 may be performed with the capping released. When the capping is released, the force with which the cap 16 presses the head 15 is released, and thus the head 15 can be easily replaced.

As shown in FIG. 2 and FIG. 3, the user moves the housing side engagement section 23 positioned at the storage position P2 to the engagement position P1. For example, the user may release the limitation of the movement by the limiting section 27 by picking up the hook 37.

The center of gravity of the housing side engagement section 23 is positioned on the opposite side to the hook 37 side with the pivot shaft 35 interposed therebetween. Therefore, when the limitation by the limiting section 27 is released, the housing side engagement section 23 is pivoted by its own weight so that the tail section 39 is lowered.

As shown in FIG. 3, the housing side engagement section 23 that has moved to the engagement position P1 is limited in pivoting when the tail section 39 contacts the stopper 29. That is, in the engagement position P1, the stopper 29 limits the pivoting of the housing side engagement section 23 in a direction away from the storage position P2.

Subsequently, the user releases the fixing of the connection section 20 with respect to the carriage 14. By this, the connection section 20 can move toward the retracting position.

As shown in FIG. 4, the user moves the connection section 20 positioned at the printing position to the retracting position. The protection section 19 and the supply tube 18 are curved as the connection section 20 is moved to the retracting position. The user engages the connection section side engagement section 22, which has been moved to the retracting position, with the housing side engagement section 23, which has been moved to the engagement position P1. Specifically, the user hooks the connection section side engagement section 22 from the lower side to the hook 37.

A force for returning the protection section 19 and the supply tube 18 to a straight state acts on the connection section 20 positioned at the retracting position. The housing side engagement section 23 receives a force from the lower side that causes the protection section 19 and the supply tube 18 to act on the connection section 20. Therefore, the connection section 20 maintains a posture of being caught by the hook 37. In the engagement position P1, a direction of the force that the housing side engagement section 23 receives from the connection section 20 substantially coincides with the direction in which the housing side engagement section 23 moves away from the storage position P2. Since the movement of the housing side engagement section 23 in a direction away from the storage position P2 is limited by the stopper 29, the housing side engagement section 23 holds the connection section 20 in a state of staying at the engagement position P1.

The user may replace the head 15 in a state where the connection section 20 is positioned at the retracting position. When the replacement is completed, the user removes the connection section side engagement section 22 from the hook 37. The user connects the connection section 20 and the head 15 by moving the connection section 20 positioned at the retracting position to the printing position.

As shown in FIG. 1, when the user moves the cover 26 to the closed position, the housing side engagement section 23 is pivoted by its own weight so that the tail section 39 is lowered. That is, the vertical relationship with the open position is inverted, and the housing side engagement section 23 moves to the storage position P2. The movement of the housing side engagement section 23 moved to the storage position P2 is limited by the contact of the arm section 38 with the limiting section 27.

### Effects of Present Embodiments

The effect of the present embodiment will be described.

(1-1) The housing side engagement section 23 is engageable with the connection section side engagement section 22. The housing side engagement section 23 has its center of gravity positioned on the opposite side from the side that engages with the connection section side engagement section 22. Therefore, the housing side engagement section 23, which is in a state where it is disengaged from the connection section side engagement section 22, takes a posture where the opposite side to the one engaging with the connection section side engagement section 22 is lowered. Therefore, the posture of the housing side engagement section 23 can be stabilized.

(1-2) The housing side engagement section 23 has the weight 40. For example, by changing the attachment position of the weight 40, the weight of the weight 40, or the like, it is possible to easily adjust the position of the center of gravity of the housing side engagement section 23.

(1-3) The housing side engagement section 23 includes the hook 37. Since the housing side engagement section 23 can be engaged with the connection section side engagement section 22 by hooking the hook 37 onto the connection section side engagement section 22, the housing side engagement section 23 and the connection section side engagement section 22 can be easily attached and detached.

(1-4) When the housing side engagement section 23 is moved from the engagement position P1, there is a possibility that the engagement between the housing side engagement section 23 and the connection section side engagement section 22 is disengaged. In this respect, the cover 26 has the stopper 29. The stopper 29 is positioned on the opposite side of the hook 37 with the pivot shaft 35 interposed therebetween. Therefore, the housing side engagement section 23 has its pivoting limited by contacting the stopper 29. Therefore, the housing side engagement section 23 is limited from moving from the engagement position P1, it is possible to reduce the possibility that the engagement between the housing side engagement section 23 and the connection section side engagement section 22 is disengaged.

(1-5) The housing 12 includes the limiting section 27. The limiting section 27 limits the pivoting of the housing side engagement section 23 at the storage position P2 and holds the housing side engagement section 23 so that it does not move from the storage position P2. Therefore, the housing side engagement section 23 can be stably moved together with the cover 26.

(1-6) In the housing side engagement section 23 of the attachment posture, the width of the thin section 47 is smaller than the width of the guide section 50. Therefore, the guide section 50, so as to pass through the thin section 47, is capable of guiding the housing side engagement section 23 in the attachment posture. Therefore, it is possible to easily attach the pivot shaft 35 to the bearing section 24.

(1-7) The housing side engagement section 23 does not take the attachment posture in the pivoting between the storage position P2 and the engagement position P1. Therefore, when the housing side engagement section 23 pivots between the storage position P2 and the engagement position P1, it is possible to reduce the possibility that the pivot shaft 35 comes off from the bearing section 24.

### Modifications

The present embodiment can be implemented with the following modifications. The present embodiment and the following modifications can be implemented in combination with each other as long as there is no technical contradiction.
The housing side engagement section 23 may take the attachment posture when attached to the cover 26.
The pivot shaft 35 may be cylindrical.
The limiting section 27 may be provided on the housing side engagement section 23.
The limiting section 27 may be a clip that clamps the housing side engagement section 23. The limiting section 27 may be a groove into which the housing side engagement section 23 is fitted. The limiting section 27 may be a stretchable band. The limiting section 27 may be an adhesive sheet to which the housing side engagement section 23 is attached.
The stopper 29 may be provided separately from the inner surface 30. The stopper 29 may limit the pivoting of the housing side engagement section 23 by contacting against the arm section 38.
The housing side engagement section 23 may be configured without the hook 37. For example, the housing side engagement section 23 may be engaged by tying a string, a chain, a wire, or the like to the connection section side engagement section 22. The housing side engagement section 23 and the connection section side engagement section 22 may be attached to each other by a magnetic force or the like.
The housing side engagement section 23 may be configured not to include the weight 40. For example, the housing side engagement section 23 may be positioned at the center of gravity of the tail section 39 by enlarging the tail section 39 or shortening the arm section 38.
The printing device 11 may be a liquid ejection device that performs recording by ejecting or discharging a liquid other than ink. The state of the liquid which is ejected from the liquid ejection device as a minute amount of liquid droplets includes a granular shape, a tear shape, and a shape with a thread-like tail. Here, the liquid may be a material which can be ejected from the liquid ejection device. For example, the liquid may be in a state where a substance is in a liquid phase and includes a fluid body such as a liquid body having high or low viscosity, sol, gel water, other inorganic solvent, an organic solvent, a solution, a liquid resin, a liquid metal, and molten metal. The liquid includes not only a liquid as one state of a substance but also a liquid in which particles of a functional material made of a solid material such as a pigment or metal particles are dissolved, dispersed, or mixed in a solvent. Typical examples of the liquid include ink and liquid crystal as described in the above embodiment. Here, the ink includes various liquid compositions such as general water-based ink, oil-based ink, gel ink, and hot-melt ink. As a specific example of the liquid ejection device, for example, there is a device that ejects a liquid containing a material such as an electrode material or a color material used for manufacturing a liquid crystal display, an electroluminescence display, a surface emitting display, a color filter, or the like in a dispersed or dissolved form. The liquid ejection device may be a device that ejects a bioorganic substance used for manufacturing a biochip, a device that is used as a precision pipette and ejects a liquid serving as a sample, a textile printing device, a micro dispenser, or the like. The liquid ejection device may be a device that ejects lubricating oil to a precision machine such as a watch or a camera in a pinpoint manner, or a device that ejects a transparent resin liquid such as an ultraviolet curable resin onto a board in order to form a micro hemispherical lens, an optical lens, or the like used in an optical communication element or the like. The liquid ejection device may be a device for ejecting an etching solution such as an acid or an alkali for etching a board or the like.

### Definition

As used herein, the expression “at least one” means “one or more” of the desired options. As an example, the expression “at least one” as used herein means “only one option” or “both of the two options” when the number of options is two. As another example, the expression “at least one” as used herein means when the number of options is three or more, “only one option”, “any combination of two options”, or “any combination of three or more options”.

### APPENDIX

Hereinafter, technical ideas grasped from the above described embodiment and modifications, and operations and effects thereof will be described.

(A) printing device includes a head configured to eject liquid; a housing that has a cover configured to open and close and that is configured to accommodate the head; a supply tube configured to supply the liquid to the head; a connection section configured to attachably and detachably connect the supply tube to the head; a connection section side engagement section provided on the connection section; and a housing side engagement section provided inside the cover, wherein the connection section side engagement section is configured to engage with the housing side engagement section in a state where the cover is open, the housing side engagement section positioned in a storage position is movable, by pivoting around a pivot shaft, to an engagement position where the housing side engagement section is engageable with the connection section side engagement section, and the center of gravity of the housing side engagement section is positioned on an opposite side to a side that engages with the connection section side engagement section with the pivot shaft interposed therebetween.

According to this configuration, the housing side engagement section is engageable with the connection section side engagement section. The center of gravity of the housing side engagement section is positioned on the opposite side to the side engaged with the connection section side engagement section. Therefore, the housing side engagement section, which is in a state where it is disengaged from the connection section side engagement section, takes a posture where the opposite side to the one that engages with the connection section side engagement section is lowered. Therefore, the attitude of the housing side engagement section can be stabilized.

(B) In the printing device according to (A), it may be such that the housing side engagement section has a weight and the weight is provided on the opposite side to the side that engages with the connection section side engagement section with the pivot shaft interposed therebetween.

According to this configuration, the housing side engagement section has the weight. For example, by changing the attachment position of the weight, the weight of the weight, or the like, it is possible to easily adjust the position of the center of gravity of the housing side engagement section.

(C) In the printing device according to (A) or (B), it may be such that the housing side engagement section has a hook configured to engage with the connection section side engagement section.

According to this configuration, the housing side engagement section includes the hook. Since the housing side engagement section can be engaged with the connection section side engagement section by hooking the hook onto the connection section side engagement section, the housing side engagement section and the connection section side engagement section can be easily attached and detached.

(D) In the printing device according to (C), it may be such that the cover has a stopper provided on an inner surface and the stopper is positioned on an opposite side to the hook with the pivot shaft interposed therebetween and, in the engagement position, limits pivoting of the housing side engagement section in a direction away from the storage position.

When the housing side engagement section is moved from the engagement position, there is a possibility that the engagement between the housing side engagement section and the connection section side engagement section is disengaged. In this respect, according to this configuration, the cover has the stopper. The stopper is positioned on the opposite side of the hook with the pivot shaft interposed therebetween. Therefore, the housing side engagement section has its pivoting limited by contacting the stopper. Therefore, it is possible to reduce the possibility that the engagement between the housing side engagement section and the connection section side engagement section is disengaged.

(E) In the printing device according to any one of (A) to (D), it may be such that the housing has a limiting section configured to limit pivoting of the housing side engagement section positioned in the storage position.

According to this configuration, the housing has the limiting section. The limiting section limits the pivoting of the housing side engagement section at the storage position. Therefore, the housing side engagement section can be stably moved together with the cover.

(F) The printing device according to any one of (A) to (E) may further include a bearing section configured to receive the pivot shaft, wherein the bearing section has a support section configured to pivotably support the pivot shaft and a guide section configured to guide the pivot shaft attached to the support section, the pivot shaft has a shaft section supported by the support section and a thin section having a width narrower than a diameter of the shaft section, and in the housing side engagement section in an attachment posture, the width of the thin section is smaller than a width of the guide section.

According to this configuration, in the housing side engagement section of the attachment posture, the width of the thin section is smaller than the width of the guide section. Therefore, the guide section, so as to pass through the thin section, is capable of guiding the housing side engagement section in the attachment posture. Therefore, it is possible to easily attach the pivot shaft to the bearing section.

(G) In the printing device according to (F), it may be such that the housing side engagement section is configured so as not to take the attachment posture when pivoting between the storage position and the engagement position.

According to this configuration, the housing side engagement section does not take the attachment posture in the pivoting between the storage position and the engagement position. Therefore, when the housing side engagement section pivots between the storage position and the engagement position, it is possible to reduce the possibility that the pivot shaft comes off from the bearing section.

What is claimed is:

1. A printing device comprising:
a head configured to eject liquid;
a housing that has a cover configured to open and close and that is configured to accommodate the head;
a supply tube configured to supply the liquid to the head;
a connection section configured to attachably and detachably connect the supply tube to the head;
a connection section side engagement section provided on the connection section; and
a housing side engagement section provided inside the cover, wherein
the connection section side engagement section is configured to engage with the housing side engagement section in a state where the cover is open,
the housing side engagement section positioned in a storage position is movable, by pivoting around a pivot shaft, to an engagement position where the housing side engagement section is engageable with the connection section side engagement section, and
the center of gravity of the housing side engagement section is positioned on an opposite side to a side that engages with the connection section side engagement section with the pivot shaft interposed therebetween.

2. The printing device according to claim 1, wherein
the housing side engagement section has a weight and
the weight is provided on the opposite side to the side that engages with the connection section side engagement section with the pivot shaft interposed therebetween.

3. The printing device according to claim 1, wherein
the housing side engagement section has a hook configured to engage with the connection section side engagement section.

4. The printing device according to claim 3, wherein
the cover has a stopper provided on an inner surface and
the stopper is positioned on an opposite side to the hook with the pivot shaft interposed therebetween and, in the engagement position, limits pivoting of the housing side engagement section in a direction away from the storage position.

5. The printing device according to claim 1, wherein
the housing has a limiting section configured to limit pivoting of the housing side engagement section positioned in the storage position.

6. The printing device according to claim 1, further comprising:
a bearing section configured to receive the pivot shaft, wherein
the bearing section has a support section configured to pivotably support the pivot shaft and a guide section configured to guide the pivot shaft attached to the support section,
the pivot shaft has a shaft section supported by the support section and a thin section having a width narrower than a diameter of the shaft section, and
in the housing side engagement section in an attachment posture, the width of the thin section is smaller than a width of the guide section.

7. The printing device according to claim 6, wherein
the housing side engagement section is configured so as not to take the attachment posture when pivoting between the storage position and the engagement position.
